(19) United States
(12) Patent Application Publication
(10) Pub. No.: US 2025/0105459 A1
(43) Pub. Date: Mar. 27, 2025

(54) POWER STORAGE MODULE

(71) Applicant: KABUSHIKI KAISHA TOYOTA JIDOSHOKKI, Kariya-shi (JP)

(72) Inventors: Takahito NAKANO, Kariya-shi (JP); Kazuki Maeda, Kariya-shi (JP); Kojiro Tamaru, Kariya-shi (JP); Takahiro Inakuma, Fukushima-shi (JP)

(73) Assignee: KABUSHIKI KAISHA TOYOTA JIDOSHOKKI, Kariya-shi (JP)

(21) Appl. No.: 18/895,566

(22) Filed: Sep. 25, 2024

(30) Foreign Application Priority Data
Sep. 27, 2023 (JP) 2023-166045

(51) Int. Cl. H01M 50/477; H01M 4/02; H01M 50/46; H01M 50/474

(52) U.S. Cl. CPC H01M 50/477; H01M 50/46; H01M 50/474; H01M 2004/029; H01M 2220/20

(57) ABSTRACT

A power storage module includes an electrode stack and a seal. The electrode stack includes a first end surface and a second end surface and a side surface. The seal includes: a side surface part; a first projecting part projecting onto the first end surface; a second projecting part projecting onto the second end surface; an overhang extending outward of the electrode stack; and a rib provided on the overhang. The side surface part includes a connecting portion to which the overhang is connected, a first side surface portion positioned between the connecting portion and the 10 first projecting part, and a second side surface portion positioned between the connecting portion and the second projecting part. The rib connects the overhang and the first side surface portion, and wherein the second side surface portion is thicker than the first side surface portion in a direction orthogonal to the side surface.

### TECHNICAL FIELD

The present disclosure relates to a power storage module. This application claims priority based on Japanese Patent Application No. 2023-166045 filed on Sep. 27, 2023, the entire contents of which are incorporated herein by reference.

### BACKGROUND

A power storage module including a seal having a side surface part provided on a side surface of an electrode stack, and a pair of projecting portions projecting onto a pair of end surfaces of the electrode stack from the side surface part is known (see, for example, WO 2020/138110 A1). A power storage unit disclosed in WO 2020/138110Al includes a seal part and an overhanging part formed on a long wall part of the seal part. The overhanging part includes an inclined portion having an inclined surface that extends downward as the distance from the outer peripheral surface of the long wall part increases in the horizontal direction. Liquid that accumulates in a gap between two power storage units falls down from the gap onto the overhanging part and moves on the inclined surface of the overhanging part, so that the liquid is separated in the horizontal direction from the gap between other power storage units. It is thus designed to suppress the liquid from entering the gap between other power storage units. As a result, short circuits caused by the liquid (short circuits through the liquid) can be suppressed.

### SUMMARY

In a case in which the seal part of the power storage unit disclosed in WO 2020/138110 A1 is formed by the injection molding of resin, the thicknesses of the pair of projecting portions may differ. If the thicknesses of the pair of projecting portions are different, the strength of the power storage module may not be ensured.

It is an object of the present disclosure to provide a power storage module that is capable of ensuring strength.

A power storage module according to an aspect of the present disclosure includes: an electrode stack including a plurality of electrodes being stacked; and a seal provided around the electrode stack to seal a space between the electrodes, wherein the electrode stack includes a first end surface and a second end surface in a stack direction of the plurality of electrodes, and a side surface extending in the stack direction to connect the first end surface and the second end surface together, wherein the seal includes: a side surface part provided on the side surface; a first projecting part projecting onto the first end surface from the side surface part; a second projecting part projecting onto the second end surface from the side surface part; an overhang extending outward of the electrode stack from the side surface part; and a rib provided on the overhang, wherein the side surface part includes a connecting portion to which the overhang is connected, a first side surface portion positioned between the connecting portion and the first projecting part, and a second side surface portion positioned between the connecting portion and the second projecting part, wherein the rib connects the overhang and the first side surface portion together, and wherein the second side surface portion is thicker than the first side surface portion in a direction orthogonal to the side surface.

In this power storage module, the rib is connected to the overhang and the first side surface portion of the side surface part, so that in a case in which injection molding is performed with a forming space of the rib (hereinafter, also simply referred to as “rib”) as an injection port of resin, paths of the resin from the rib to a forming space of the first side surface portion (hereinafter, also simply referred to as “first side surface portion”) include a path in which the rib and the first side surface portion are directly connected without passing through a forming space of the overhang (hereinafter, also simply referred to as “overhang”) as well as a path that passes through the overhang. However, the only path of the resin from the rib to a forming space of the second side surface portion of the side surface part (hereinafter, also simply referred to as “second side surface portion”) is a path that passes through the overhang.

Consequently, the resin injected from the rib flows more easily into the first side surface portion than into the second side surface portion. The second side surface portion is thicker than the first side surface portion, so that the resin flows more easily in the second side surface portion than in the first side surface portion. Thus, the amount of resin that flows into a forming space of the first projecting part (hereinafter, also simply referred to as “first projecting part”) positioned downstream of the first side surface portion and the amount of resin that flows into a forming space of the second projecting part (hereinafter, also simply referred to as “second projecting part”) positioned downstream of the second side surface portion tend not to differ. As a result, differences in the thicknesses of the first projecting part and the second projecting part can be suppressed. Consequently, the strength of the power storage module can be ensured.

The second side surface portion may include a thick part at a position facing the rib in the stack direction with the overhang interposed therebetween.

The rib may include a body part being plate-like, connecting the overhang and the first side surface portion together, and a column part spaced from the side surface part and protruding in the stack direction from the overhang, and the column part may be thicker than the body part in a direction orthogonal to the stack direction and parallel to the side surface.

The body part may be connected to the first side surface portion at a position spaced from the first projecting part in the stack direction.

The body part may include a first body portion connected to the first side surface portion, and a second body portion connected to the column part, and a distance at which the first body portion is spaced from the first projecting part in the stack direction may be greater than a distance at which the second body portion is spaced from the first projecting part in the stack direction.

A power storage module according to another aspect of the present disclosure includes: an electrode stack including a plurality of electrodes being stacked along a stack direction; and a seal provided around the electrode stack to seal a space between the electrodes, wherein the electrode stack includes a first end surface and a second end surface in the stack direction, and a side surface extending in the stack direction to connect the first end surface and the second end surface together, wherein the seal includes: a side surface part provided on the side surface; a first projecting part projecting onto the first end surface from the side surface part; a second projecting part projecting onto the second end surface from the side surface part; an overhang extending outward of the electrode stack from the side surface part; and a rib provided on the overhang, wherein the side surface part includes a connecting portion to which the overhang is connected, a first side surface portion positioned between the connecting portion and the first projecting part, and a second side surface portion positioned between the connecting portion and the second projecting part, wherein the rib includes a body part being plate-like, connecting the overhang and the first side surface portion together, and a column part spaced from the first side surface portion and protruding in the stack direction from the overhang, and wherein the column part is thicker than the body part in a direction orthogonal to the stack direction and parallel to the side surface.

In this power storage module, the rib is connected to the overhang and the first side surface portion of the side surface part, so that in a case in which injection molding is performed with the rib as an injection port of resin, paths of the resin from the rib to the first side surface portion include a path in which the rib and the first side surface portion are directly connected without passing through the overhang as well as a path that passes through the overhang. However, the only path of the resin from the rib to the second side surface portion of the side surface part is a path that passes through the overhang. Consequently, the resin injected from the rib flows more easily into the first side surface portion than into the second side surface portion. The rib has the column part spaced from the first side surface portion and protruding from the overhang in addition to the body part being plate-like. The column part is thicker than the body part, so that injection molding with a forming space of the column part (hereinafter, also simply referred to as “column part”) as the injection port of the resin facilitates the flow of resin into the overhang. This suppresses the flow of the resin directly into the first side surface portion from the rib without passing through the overhang. That is, the amount of resin that flows into the first side surface portion and the second side surface portion tends not to differ compared to a case in which the column part has the same thickness as the body part. Thus, the amount of resin that flows into the first projecting part positioned downstream of the first side surface portion and the second projecting part positioned downstream of the second side surface portion tends not to differ. As a result, differences in the thicknesses of the first projecting part and the second projecting part can be suppressed. Consequently, the strength of the power storage module can be ensured.

In the power storage module according to the other aspect above, the body part may be connected to the first side surface portion at a position spaced from the first projecting part in the stack direction.

In the power storage module according to the other aspect above, the body part may include a first body portion connected to the first side surface portion, and a second body portion connected to the column part, and a distance at which the first body portion is spaced from the first projecting part in the stack direction may be greater than a distance at which the second body portion is spaced from the first projecting part in the stack direction.

### BRIEF DESCRIPTION OF THE DRAWINGS

FIG. 1 is a schematic cross-sectional view illustrating a power storage device according to an embodiment including a first direction and a second direction.

FIG. 2 is a schematic cross-sectional view illustrating the power storage device according to an embodiment including the first direction and a third direction.

FIG. 3 is a schematic cross-sectional view illustrating a power storage module shown in FIGS. 1 and 2.

FIG. 4 is a perspective view illustrating the power storage module shown in FIGS. 1 to 3.

FIG. 5 is an enlarged perspective view illustrating a rib and a vicinity thereof.

FIG. 6 is an enlarged perspective view illustrating the rib and the vicinity thereof.

FIG. 7 is an enlarged plan view illustrating the rib and the vicinity thereof.

FIG. 8 is an enlarged side view illustrating the rib and the vicinity thereof.

FIG. 9 is an enlarged cross-sectional view illustrating the rib and the vicinity thereof.

FIG. 10 is a cross-sectional view for describing an inner seal forming step.

FIG. 11 is a cross-sectional view for describing an outer seal forming step.

### DETAILED DESCRIPTION

An embodiment of a power storage device will be described below with reference to the drawings. Same reference signs are given to the same or equivalent elements in the description of the drawings, and redundant description may be omitted. Additionally, each drawing illustrates a rectangular coordinate system composed of a first axis defining a first direction D1, a second axis defining a second direction D2, and a third axis defining a third direction D3. For example, the first direction D1 is a vertical direction, and the second direction D2 and the third direction D3 are two horizontal directions intersecting each other.

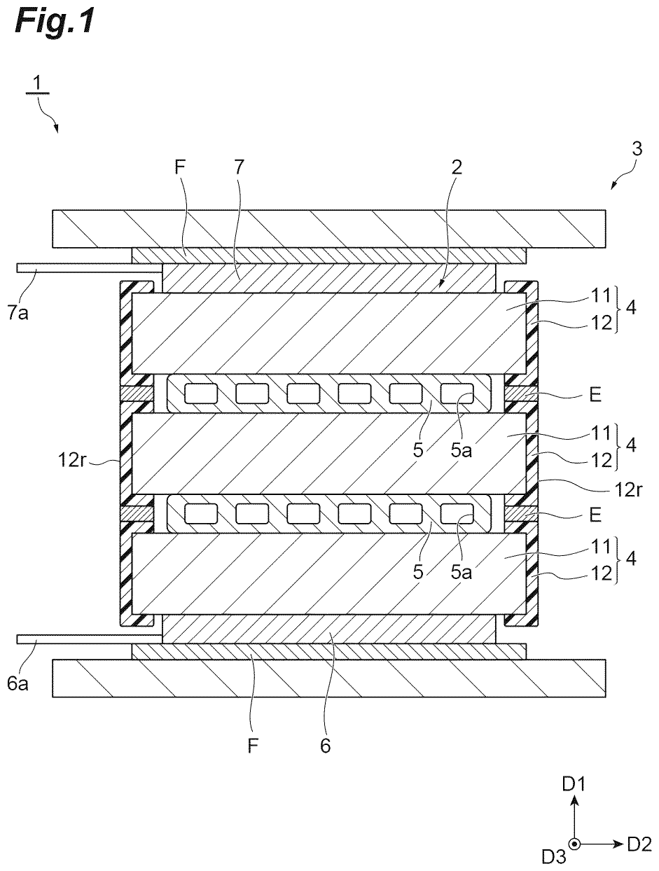

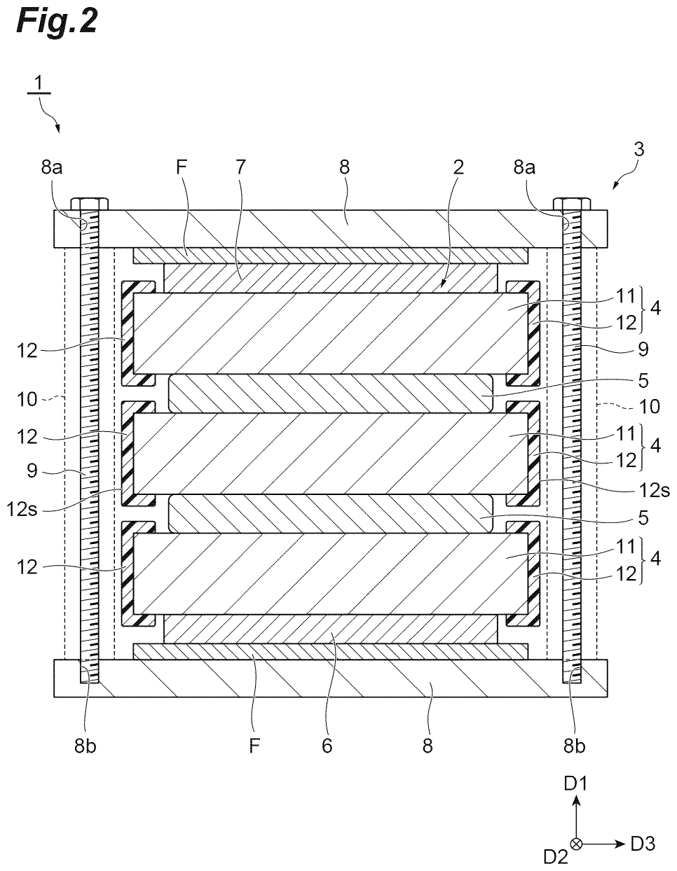

FIG. 1 is a schematic cross-sectional view illustrating a power storage device according to an embodiment including a first direction and a second direction. FIG. 2 is a schematic cross-sectional view illustrating the power storage device according to an embodiment including the first direction and a third direction. A power storage device 1 illustrated in FIGS. 1 and 2 can be used for the battery of various vehicles such as forklifts, hybrid vehicles, and electric vehicles. The power storage device 1 includes a module stack 2 that includes a plurality of power storage modules 4 stacked along the first direction D1, and a restraint member 3 that applies a restraint load on the module stack 2 along the first direction D1.

The module stack 2 includes a plurality of (in this case, three) power storage modules 4, and a plurality of (in this case, two) conductive plates 5. The power storage modules 4 are, for example, bipolar batteries, and have a rectangular shape when viewed in the first direction D1. More specifically, the power storage modules 4 have a rectangular shape having long sides and short sides when viewed in the first direction D1. The power storage modules 4 are, for example, secondary batteries such as nickel-hydrogen batteries or lithium-ion batteries, or electric double layer capacitors. The description below exemplifies nickel-hydrogen secondary batteries.

In the module stack 2, the conductive plates 5 are interposed between the power storage modules 4 adjacent along the first direction D1. The plurality of power storage modules 4 are thus electrically connected via the conductive plates 5. More specifically, each power storage module 4 has a positive terminal surface on one end surface in the first direction D1 and a negative terminal surface on the other end surface in the first direction D1, and the plurality of power storage modules 4 stacked via the conductive plates 5 are connected in series. A current collector 6 from which a positive terminal 6a extends is disposed outside the power storage module 4 positioned at one end in the first direction D1 of the module stack 2, and is electrically connected to the power storage module 4. A current collector 7 from which a negative terminal 7a extends is disposed outside the power storage module 4 positioned at the other end in the first direction D1 of the module stack 2, and is electrically connected to the power storage module 4. The power storage device 1 is charged and discharged using the positive terminal 6a and the negative terminal 7a.

A plurality of flow paths 5a for circulating a coolant such as air are provided inside the conductive plates 5. The flow paths 5a extend, for example, along a direction (in this case, the third direction D3) intersecting (orthogonal to) both the first direction D1 and a direction of extension of the positive terminal 6a and the negative terminal 7a. The conductive plates 5 function as connecting members for electrically connecting the power storage modules 4 to each other, and as heat dispersing members for dispersing heat generated in the power storage modules 4 by circulating a coolant in the flow paths 5a thereof.

The restraint member 3 includes a pair of restraint plates 8 that sandwich the module stack 2 in a stack direction, a plurality of fasteners 9 such as bolts that connect the restraint plates 8 by fastening them to each other, and supports 10 that accommodate the bodies (e.g., shafts of the bolts) of the fasteners 9. The restraint plates 8 are rectangular metal plates having an area slightly larger than the area of the power storage modules 4 and the conductive plates 5 when viewed in the first direction D1. The restraint plates 8 have a rectangular shape having long sides and short sides when viewed in the first direction D1. A plate-like insulating member F is provided on an inner surface (surface closer to the module stack 2) of each of the restraint plates 8. That is, the current collector 6 or the current collector 7 and the insulating member F are interposed between the module stack 2 and the restraint plates 8. The restraint plates 8 are thus insulated from the module stack 2 (specifically, the current collectors 6, 7).

Insertion holes 8a are provided in edge parts of one of the restraint plates 8 at positions outward of the module stack 2 when viewed in the first direction D1, and screw holes 8b are provided in edge parts of the other restraint plate 8 at positions facing the insertion holes 8a. The fasteners 9 are passed through the insertion holes 8a of the one of the restraint plates 8 toward the screw holes 8b of the other restraint plate 8, and screwed into the screw holes 8b of the other restraint plate 8. Consequently, the power storage modules 4 and the conductive plates 5 are sandwiched by the restraint plates 8 to be unitized as the module stack 2, and a restraint load is applied to the module stack 2 along the first direction D1.

The fasteners 9 are thus disposed outward of the module stack 2, extend along the first direction D1, and fasten the pair of restraint plates 8 to each other along the first direction D1 to restrain the module stack 2. The supports 10 are interposed between the pair of restraint plates 8, and extend along the first direction D1 together with the fasteners 9. The supports 10 define the restraining force to the module stack 2 by defining the distance between the pair of restraint plates 8 in the first direction D1.

In the power storage device 1, a plurality of connecting members, each formed of one fastener 9 and one support 10 that accommodates the fastener 9, are arranged along the long sides of the restraint plates 8 when viewed in the first direction D1. The connecting members face each other in a direction along the short sides of the restraint plates 8 when viewed in the first direction D1. The closer the connecting members facing each other are to one another, the more possible it is to uniformly apply a restraint load to the power storage modules 4 via the restraint plates 8.

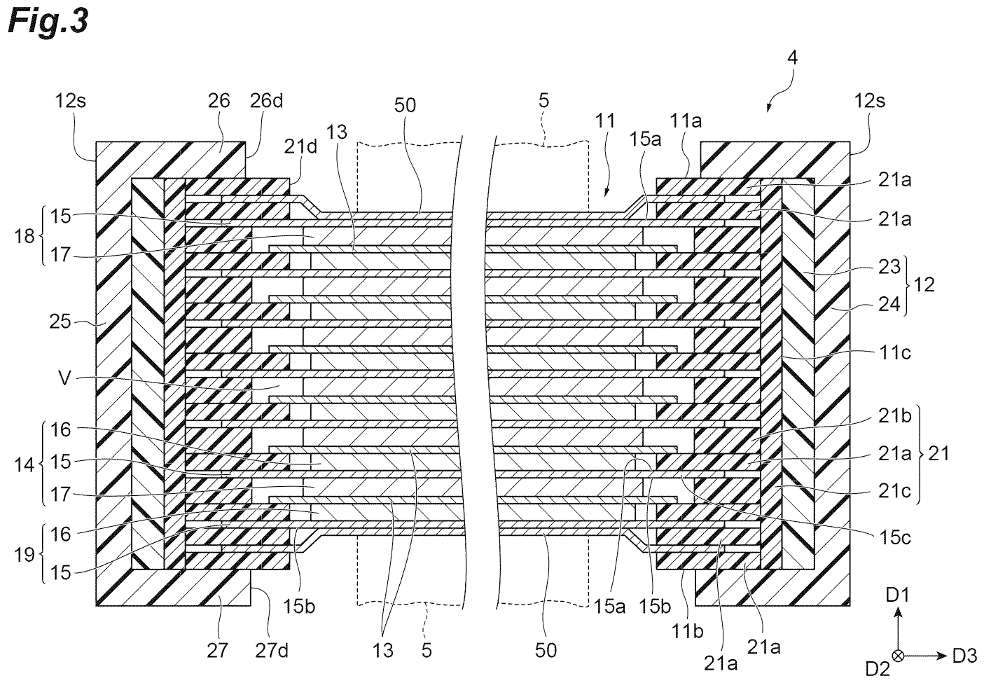

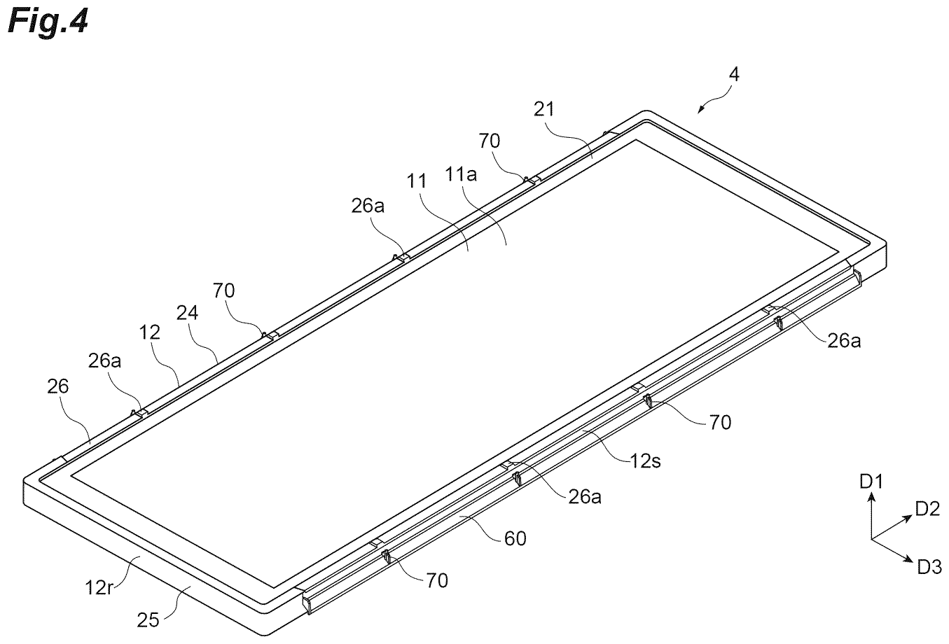

FIG. 3 is a schematic cross-sectional view illustrating a power storage module shown in FIGS. 1 and 2. FIG. 4 is a perspective view illustrating the power storage module shown in FIGS. 1 to 3. As illustrated in FIGS. 3 and 4, the power storage module 4 includes an electrode stack 11, and a resin second seal part 12 that seals the electrode stack 11. The electrode stack 11 includes a plurality of electrodes (a plurality of bipolar electrodes 14, a negative terminal electrode 18, and a positive terminal electrode 19) which are stacked along the first direction D1 via separators 13. Here, the stack direction of the electrodes matches the stack direction of the power storage modules 4.

Each bipolar electrode 14 includes an electrode plate 15 having a first surface 15a and a second surface 15b opposite the first surface 15a, a positive electrode active material layer 16 provided on the first surface 15a, and a negative electrode active material layer 17 provided on the second surface 15b. In the electrode stack 11, the positive electrode active material layer 16 of one bipolar electrode 14 faces the negative electrode active material layer 17 of another bipolar electrode 14 adjacent in the first direction D1 with the separator 13 interposed therebetween. In the electrode stack 11, the negative electrode active material layer 17 of one bipolar electrode 14 faces the positive electrode active material layer 16 of another bipolar electrode 14 adjacent in the first direction D1 with the separator 13 interposed therebetween.

The negative terminal electrode 18 includes the electrode plate 15, and the negative electrode active material layer 17 provided on the second surface 15b of the electrode plate 15. No active material layers are provided on the first surface 15a of the electrode plate 15 of the negative terminal electrode 18. The negative terminal electrode 18 is disposed at one end of the electrode stack 11 in the first direction D1 such that the second surface 15b thereof is on an inner side (toward the center in the first direction D1) of the electrode stack 11. The negative electrode active material layer 17 of the negative terminal electrode 18 faces the positive electrode active material layer 16 of the bipolar electrode 14 at one end in the first direction D1 via the separator 13.

The positive terminal electrode 19 includes the electrode plate 15, and the positive electrode active material layer 16 provided on the first surface 15a of the electrode plate 15. No active material layers are provided on the second surface 15b of the electrode plate 15 of the positive terminal electrode 19. The positive terminal electrode 19 is disposed at the other end of the electrode stack 11 in the first direction D1 such that the first surface 15a thereof is on an inner side of the electrode stack 11. The positive electrode active material layer 16 of the positive terminal electrode 19 faces the negative electrode active material layer 17 of the bipolar electrode 14 at the other end in the first direction D1 via the separator 13.

The first surface 15a of the electrode plate 15 of the negative terminal electrode 18 is a surface that faces the outside of the electrode stack 11. The conductive plate 5 is electrically connected to the first surface 15a of the negative terminal electrode 18 via a metal plate 50 which will be described further below. The second surface 15b of the electrode plate 15 of the positive terminal electrode 19 is a surface that faces the outside of the electrode stack 11. Another conductive plate 5 is electrically connected to the second surface 15b of the positive terminal electrode 19 via the metal plate 50 which will be described further below.

The electrode plate 15 is made of metal such as nickel or nickel plated steel plate. For example, the electrode plate 15 is a rectangular metal foil made of nickel. A peripheral part (peripheral parts of the bipolar electrode 14, the negative terminal electrode 18, and the positive terminal electrode 19) 15c of the electrode plate 15 has a rectangular frame shape, and is a region in which the positive electrode active material layer 16 and the negative electrode active material layer 17 are not formed. An example of the positive electrode active material that forms the positive electrode active material layer 16 includes nickel hydroxide. An example of the negative electrode active material that forms the negative electrode active material layer 17 includes hydrogen storage alloy.

The separator 13 is formed, for example, in a sheet shape. Examples of the separator 13 include a porous film made of a polyolefin resin such as polyethylene (PE) and polypropylene (PP), and woven or non-woven fabric made of polypropylene, polyethylene terephthalate (PET), methylcellulose, etc. The separator 13 may be reinforced with a vinylidene fluoride resin compound.

The electrode stack 11 includes a plurality of first seal parts 21 made of an insulating resin. Each of the plurality of first seal parts 21 includes a first portion 21a, a second portion 21b, and a third portion 21c. The first portion 21a is formed in a rectangular frame shape when viewed in the first direction D1, and is bonded (e.g., welded) to the peripheral part 15c of the electrode plate 15. The second portion 21b has a rectangular frame shape when viewed in the first direction D1, and is disposed on a part of the first portion 21a. That is, an inner edge of the second portion 21b is positioned outward of an inner edge of the first portion 21a when viewed in the first direction D1. A peripheral part of the separator 13 is disposed on and bonded (e.g., welded) to the part of the first portion 21a exposed from the second portion 21b.

The third portion 21c has a rectangular cylindrical shape extending along the first direction D1, and bonds the plurality of the first portions 21a and the plurality of the second portions 21b to each other to integrate them. The first portion 21a and the second portion 21b can be formed, for example, by folding a sheet-like member. In this case, the third portion 21c is a welded end part that is formed, for example, by welding together the folded part of the sheet-like member (outer end parts of the first portion 21a and the second portion 21b) arranged along the first direction D1. The third portion 21c does not necessarily need to be provided around the entire peripheral part of the first seal part 21, and may be provided partly around the peripheral part of the first seal part 21.

The electrode stack 11 has a first end surface 11a and a second end surface 11b in the first direction D1, and a side surface 11c that extends in the first direction D1 so as to connect the first end surface 11a and the second end surface 11b together. The first end surface 11a is formed of an outer surface of the metal plate 50 that forms a negative terminal surface of the power storage module 4, and an outer surface of the first seal part 21 provided on the metal plate 50. The second end surface 11b is formed of an outer surface of the metal plate 50 that forms a positive terminal surface of the power storage module 4, and an outer surface of the first seal part 21 provided on the metal plate 50. The side surface 11c is formed of an outer surface of the third portion 21c.

The second seal part 12 is formed in a generally rectangular cylindrical shape, for example, by an insulating resin. The second seal part 12 is provided around the electrode stack 11 so as to surround the electrode stack 11. The second seal part 12 is formed, for example, by injection molding of resin, and extends along the entire length of the electrode stack 11 in the first direction D1.

The second seal part 12 has an inner seal 23 and outer seal 24 (seal). The inner seal 23 is bonded to the first seal part 21 so as to surround the first seal part 21 from outside. The inner seal 23 is welded to the outer surface of the first seal part 21, for example, by the heat during injection molding. The inner seal 23 is provided on the side surface 11c in contact with the side surface 11c. The inner seal 23 covers the entirety of the side surface 11c in the first direction D1. A length of the inner seal 23 in the first direction D1 is the same as a length of the side surface 11c in the first direction D1. The inner seal 23 is provided in a cylindrical shape so as to cover the entire periphery of the electrode stack 11 when viewed in the first direction D1.

The outer seal 24 is bonded to the inner seal 23 so as to surround the inner seal 23 from outside. The outer seal 24 has a side surface part 25, a first projecting part 26, and a second projecting part 27. The side surface part 25, the first projecting part 26, and the second projecting part 27 are integrally formed, for example, by injection molding. The side surface part 25 is provided on the side surface 11c with the inner seal 23 interposed therebetween. The side surface part 25 is welded to an outer surface of the inner seal 23, for example, by the heat during injection molding. The outer seal 24 is provided in a cylindrical shape so as to cover the entire periphery of the electrode stack 11 when viewed in the first direction D1.

The first projecting part 26 projects onto the first end surface 11a from one end part of the side surface part 25 in the first direction D1. The second projecting part 27 projects onto the second end surface 11b from the other end part of the side surface part 25 in the first direction D1. That is, the first projecting part 26 is a portion that extends inward of an inner peripheral edge of the side surface part 25 when viewed in the first direction D1. Similarly, the second projecting part 27 is a portion that extends inward of the inner peripheral edge of the side surface part 25 when viewed in the first direction D1. An inner edge 26d of the first projecting part 26 and an inner edge 27d of the second projecting part 27 are positioned outward of an inner edge 21d of the first seal part 21 when viewed in the first direction D1. The first projecting part 26 and the second projecting part 27 have the same thickness (length in the first direction D1). The first projecting part 26 and the second projecting part 27 are provided continuously along all sides of the electrode plates 15. The first projecting part 26 and the second projecting part 27 are formed in a rectangular frame shape when viewed in the first direction D1.

The first seal part 21 and the second seal part 12 seal spaces between the bipolar electrodes 14 adjacent in the first direction D1, a space between the negative terminal electrode 18 and the bipolar electrode 14, and a space between the positive terminal electrode 19 and the bipolar electrode 14. Inner spaces V, which are airtightly partitioned, are thus formed between the bipolar electrodes 14, between the negative terminal electrode 18 and the bipolar electrode 14, and between the positive terminal electrode 19 and the bipolar electrode 14. That is, the first seal part 21 and the second seal part 12 are for forming the inner spaces V between the electrodes, and for sealing the inner spaces V. The inner spaces V accommodate an electrolyte (not shown) made of an alkaline solution such as a potassium hydroxide solution. At least a portion of the electrolyte can be impregnated into the separators 13, the positive electrode active material layers 16, and the negative electrode active material layers 17.

The first seal part 21 and the second seal part 12 are, for example, an insulating resin, and can be formed of polypropylene (PP), polyphenylene sulfide (PPS), modified polyphenylene ether (modified PPE), or the like.

As illustrated in FIGS. 1 to 4, the second seal part 12 includes a pair of outer peripheral surfaces 12s, and a pair of outer peripheral surfaces 12r which connect the outer peripheral surfaces 12s to each other. The outer peripheral surfaces 12s and the outer peripheral surfaces 12r are surfaces extending along the first direction D1. Here, the outer peripheral surfaces 12s are surfaces intersecting (orthogonal to) the third direction D3, and the outer peripheral surfaces 12r are surfaces intersecting (orthogonal to) the second direction D2. Additionally, a length of the outer peripheral surfaces 12s in the second direction D2 is greater than a length of the outer peripheral surfaces 12r in the third direction D3. In the conductive plates 5 described above, the flow paths 5a extend along the third direction D3, and opens onto a pair of surfaces of the conductive plates 5 intersecting the third direction D3.

Accordingly, gaps on the outer peripheral surface 12s side of the second seal parts 12 of adjacent power storage modules 4 are utilized for the introduction and ejection of the coolant into and from the flow paths 5a. However, gaps on the outer peripheral surface 12r side of the second seal parts 12 of adjacent power storage modules 4 are not utilized for the introduction and ejection of the coolant into and from the flow paths 5a. Thus, in the module stack 2, the gaps on the outer peripheral surface 12s side of the second seal parts 12 of adjacent power storage modules 4 are open, and the gaps on the outer peripheral surface 12r side are filled with a sealing material E.

Here, the power storage module 4 may include a pair of the metal plates 50. In this embodiment, the metal plates 50 are respectively provided on one end (end part on the negative terminal electrode 18 side) and the other end (end part on the positive terminal electrode 19 side) of the electrode stack 11 in the first direction D1. One of the pair of metal plates 50 is in contact with the first surface 15a of the electrode plate 15 of the negative terminal electrode 18 and the conductive plate 5. The other of the pair of metal plates 50 is in contact with the second surface 15b of the electrode plate 15 of the positive terminal electrode 19 and another conductive plate 5. Thus, in the power storage module 4, the metal plates 50 are provided outside of the negative terminal electrode 18 and the positive terminal electrode 19. The metal plate 50 disposed at one end of the power storage module 4 in the first direction D1 is in contact with the negative terminal electrode 18, and forms a negative terminal surface of the power storage module 4. The metal plate 50 disposed at the other end of the power storage module 4 in the first direction D1 is in contact with the positive terminal electrode 19, and forms a positive terminal surface of the power storage module 4.

A peripheral part of one of the pair of metal plates 50 is sandwiched between the first portion 21a of the first seal part 21 provided on the electrode plate 15 of the negative terminal electrode 18 and another first portion 21a provided opposite the first portion 21a. The pair of the first portions 21a are integrated by being bonded (e.g., welded) by the third portion 21c. A peripheral part of the other of the pair of metal plates 50 is sandwiched between the first portion 21a of the first seal part 21 provided on the electrode plate 15 of the positive terminal electrode 19 and another first portion 21a provided opposite the first portion 21a. The pair of these first portions 21a are also integrated by being bonded (e.g., welded) by the third portion 21c. The metal plates 50 are uncoated foil for which no active material layers are formed on either side. The same metal foil (uncoated foil) as that of the electrode plates 15 can be used for the metal plates 50.

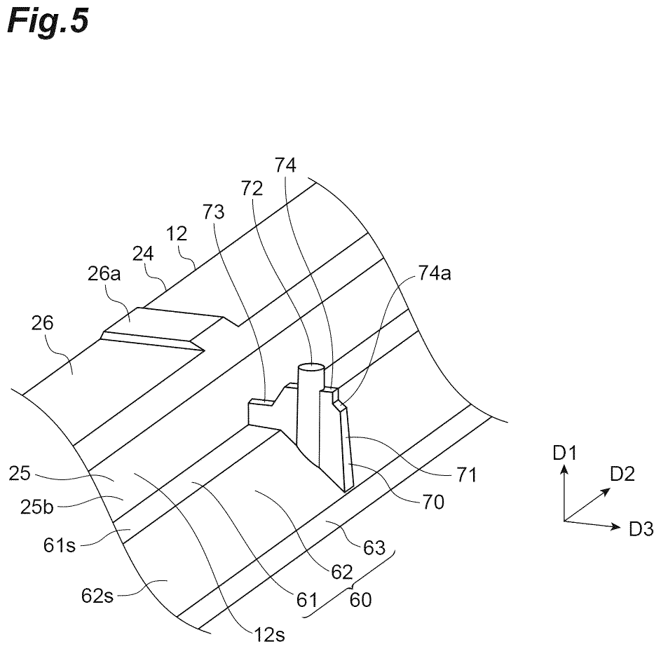

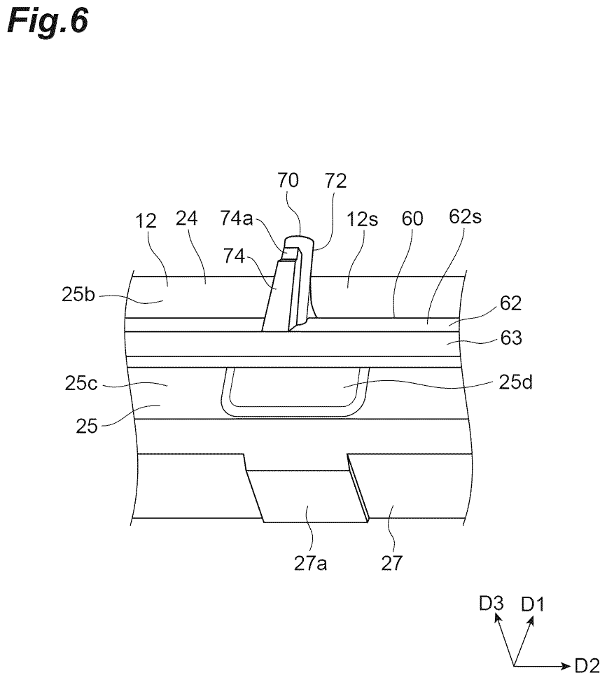

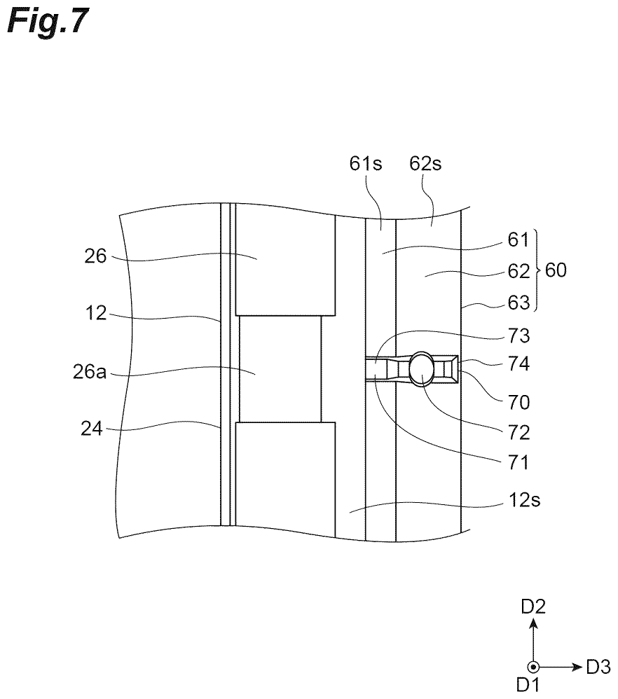

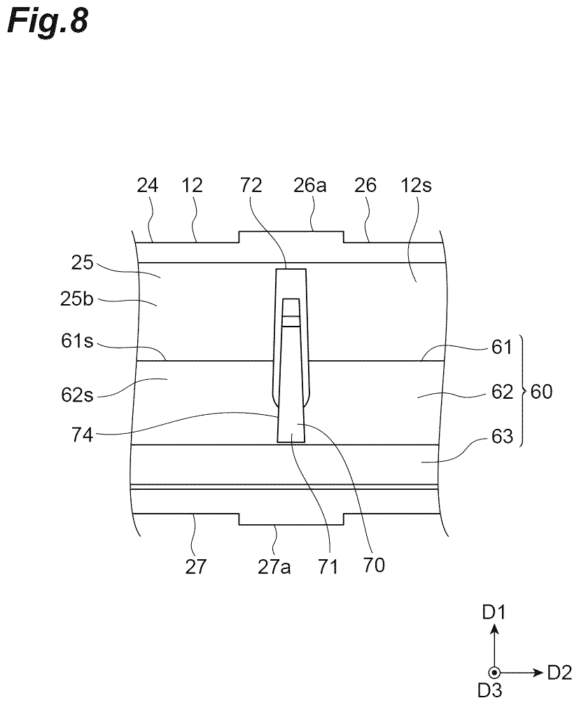

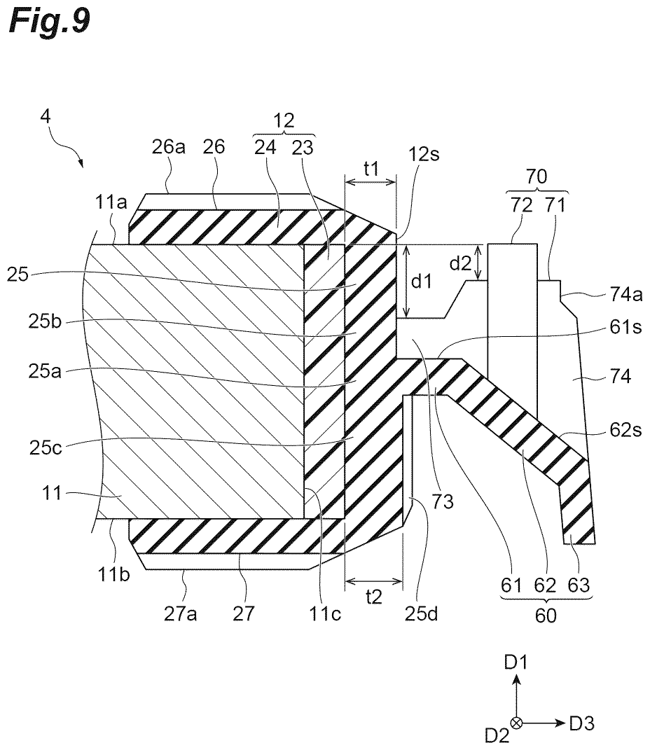

The second seal part 12 will next be described in detail. FIG. 5 is a partial perspective view of a rib and a vicinity thereof viewed from above in the first direction D1. FIG. 6 is a partial perspective view of the rib and the vicinity thereof viewed from below in the first direction D1. FIG. 7 is an enlarged plan view illustrating the rib and the vicinity thereof. FIG. 8 is an enlarged side view illustrating the rib and the vicinity thereof. FIG. 9 is an enlarged cross-sectional view illustrating the rib and the vicinity thereof. As illustrated in FIGS. 4 to 9, the outer seal 24 has an overhang 60 and a rib 70. The overhang 60 and the rib 70 are formed integrally with the side surface part 25, the first projecting part 26, and the second projecting part 27, for example, by injection molding. That is, the side surface part 25, the first projecting part 26, the second projecting part 27, the overhang 60, and the rib 70 are formed as one member in a single injection molding process.

The overhang 60 functions to suppress the phenomenon in which liquid attached to the vicinity of one of the terminal surfaces of the power storage module 4 flows down the outer peripheral surface of the outer seal 24 toward the other terminal surface of the power storage module 4, to thereby cause the positive terminal surface and the negative terminal surface of the power storage module 4 to short circuit via the liquid, i.e., the so-called short circuit through liquid. The liquid is, for example, an electrolyte leaked from inside the power storage module 4, or dew condensation water from outside the power storage module 4. As described above, the gaps on the outer peripheral surface 12r side of the second seal parts 12 of adjacent power storage modules 4 are filled with the sealing material E (see FIG. 1), so that it is not necessary to provide the outer peripheral surfaces 12r of the power storage modules 4 with the overhang 60. Consequently, in the power storage module 4, the overhang 60 is provided only on the outer peripheral surfaces 12s of the outer peripheral surfaces 12s, 12r of the second seal part 12. The overhang 60 is integrated with the side surface part 25, and is an elongate plate-like protruding part extending in the second direction D2.

The overhang 60 extends outward of the electrode stack 11 from an outer surface of the side surface part 25 that forms the outer peripheral surface 12s. The overhang 60 extends along the outer peripheral surface 12s in the second direction D2. The side surface part 25 has a connecting portion 25a, a first side surface portion 25b, and a second side surface portion 25c. The overhang 60 is connected to the connecting portion 25a. The connecting portion 25a is provided in the center of the side surface 11c in the first direction D1. The first side surface portion 25b is positioned between the connecting portion 25a and the first projecting part 26, and connects the connecting portion 25a and the first projecting part 26 together. The second side surface portion 25c is positioned between the connecting portion 25a and the second projecting part 27, and connects the connecting portion 25a and the second projecting part 27 together.

In a direction orthogonal to the side surface 11c (third direction D3), a thickness t2 of the second side surface portion 25c is greater than a thickness t1 of the first side surface portion 25b (t2>t1). In this embodiment, the thickness t1 of the first side surface portion 25b is constant across the entirety of the first side surface portion 25b in the second direction D2, but it need not be constant. Additionally, the thickness t2 of the second side surface portion 25c is constant across the entirety of the second side surface portion 25c in the second direction D2, but it need not be constant. In the case in which the thickness t1 of the first side surface portion 25b and the thickness t2 of the second side surface portion 25c are not constant, it is only required that at least the average value of the thickness t2 of the second side surface portion 25c is greater than the average value of the thickness t1 of the first side surface portion 25b. For example, the minimum value of the thickness t2 of the second side surface portion 25c may be greater than or equal to the maximum value of the thickness t1 of the first side surface portion 25b.

The second side surface portion 25c has a thick part 25d at a position facing the rib 70 in the first direction D1 with the overhang 60 interposed therebetween. The thick part 25d is the portion that bulges outward of the electrode stack 11. The thick part 25d is provided in contact with the overhang 60.

The overhang 60 includes a base end part 61, an inclined part 62, and a distal end part 63. The base end part 61 is connected to the side surface part 25. The base end part 61 protrudes in a direction perpendicular to the outer peripheral surface 12s (third direction D3) from the outer peripheral surface 12s. An upper surface 61s of the base end part 61 is a flat surface (horizontal surface) that extends along the second direction D2 and the third direction D3. The upper surface 61s is a surface that faces upward in the first direction D1. The upper surface 61s is adjacent the first side surface portion 25b, and is continuous with the first side surface portion 25b.

The inclined part 62 connects the base end part 61 and the distal end part 63 together. The inclined part 62 is inclined relative to the third direction D3 such that the distance from the outer peripheral surface 12s gradually increases toward the bottom (vertically downward) in the first direction D1. Consequently, an upper surface 62s of the inclined part 62 is an inclined surface that is inclined so as to be separated from the outer peripheral surface 12s toward the bottom in the first direction D1. The upper surface 62s is a surface that faces upward in the first direction D1. The upper surface 62s is adjacent the upper surface 61s, and is continuous with the upper surface 61s.

The distal end part 63 extends from a tip end of the inclined part 62 so as to be inclined relative to the third direction D3 at an angle greater than an angle at which the inclined part 62 is inclined relative to the third direction D3. This improves drip prevention of the liquid that flows along the overhang 60. It should be noted that the distal end part 63 may extend substantially perpendicularly downward from the tip end of the inclined part 62 such that the distance from the outer peripheral surface 12s is substantially constant regardless of the position in the first direction D1. A tip end (lower end) of the distal end part 63 is set at a position that does not protrude from the side surface part 25 and the second projecting part 27 in the first direction D1.

The rib 70 is provided on the overhang 60 and reinforces the overhang 60. A plurality of the ribs 70 are provided at predetermined intervals along a direction of extension of the overhang 60 (second direction D2). The rib 70 has a plate-like body part 71 and a column part 72. The body part 71 connects the overhang 60 and the first side surface portion 25b together. The body part 71 protrudes upward in the first direction D1 from the upper surface 61s of the base end part 61 and the upper surface 62s of the inclined part 62. The body part 71 is provided across the entirety of the upper surface 61s and the upper surface 62s in the direction orthogonal to the side surface 11c (third direction D3). The body part 71 is connected to the first side surface portion 25b at a position spaced from the first projecting part 26 in the first direction D1.

The body part 71 has a first body portion 73 that is connected to the first side surface portion 25b, and a second body portion 74 that is connected to the column part 72. The first body portion 73 is provided on the upper surface 61s. The first body portion 73 has a rectangular shape when viewed in the second direction D2. The first body portion 73 is spaced from the first projecting part 26 in the first direction D1 by a distance d1 (d1>0). The second body portion 74 is provided on the upper surface 62s. The second body portion 74 is connected to both sides of the column part 72 in the third direction D3, and sandwiches the column part 72 in the third direction D3.

The distance d1 at which the first body portion 73 is spaced from the first projecting part 26 in the stack direction is greater than a distance d2 at which the second body portion 74 is spaced from the first projecting part 26 in the stack direction (d1>d2). Thus, a step is formed between the first body portion 73 and the second body portion 74. The step is formed of an inclined surface. It can also be said that the portion of the body part 71 adjacent the first side surface portion 25b is provided with a notch. It should be noted that a notch 74a is formed on an upper end of the second body portion 74 on a side opposite from the first body portion 73 in FIG. 5, but this notch 74a is, for example, a structure provided due to the properties of the manufacturing device, and is not an essential structure of the body part 71.

The column part 72 protrudes upward in the first direction D1 from the upper surface 62s of the inclined part 62. A tip end (upper end) of the column part 72 is set at a position that does not protrude from the first projecting part 26 in the first direction D1. The column part 72 has a cylindrical shape with a circular cross-section. The column part 72 is formed at the center of the upper surface 62s in the third direction D3. The column part 72 divides the second body portion 74 of the body part 71 in the direction orthogonal to the side surface 11c (third direction D3). The column part 72 is thicker than the body part 71 in a direction orthogonal to the stack direction (first direction D1) and parallel to the side surface 11c (second direction D2). The column part 72 protrudes above the body part 71 in the first direction D1.

A protrusion 26a that protrudes upward is provided on an upper surface of the first projecting part 26 at a position corresponding to the rib 70. A protrusion 27a that protrudes downward is provided on a lower surface of the second projecting part 27 at a position corresponding to the rib 70. In the power storage device 1, the power storage modules 4 adjacent in the first direction D1 are disposed such that the protrusion 26a and the protrusion 27a face each other in the first direction D1. Even if the power storage modules 4 expand, gaps between the power storage modules 4 can be ensured by bringing the protrusion 26a and the protrusion 27a in contact with each other.

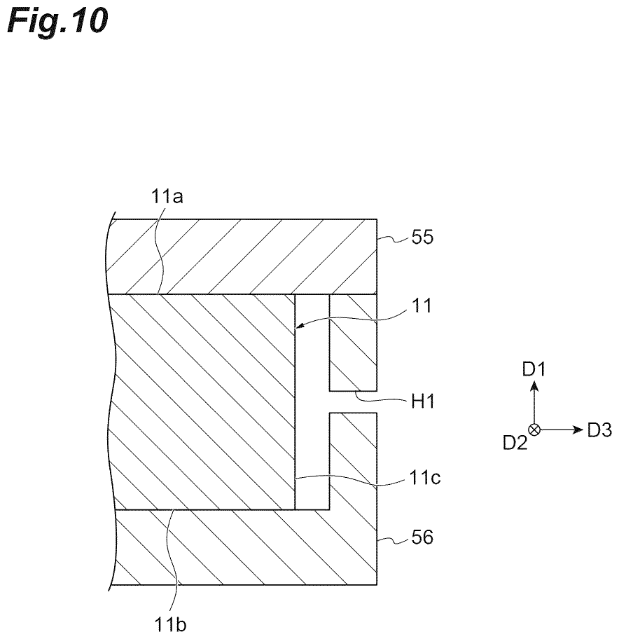

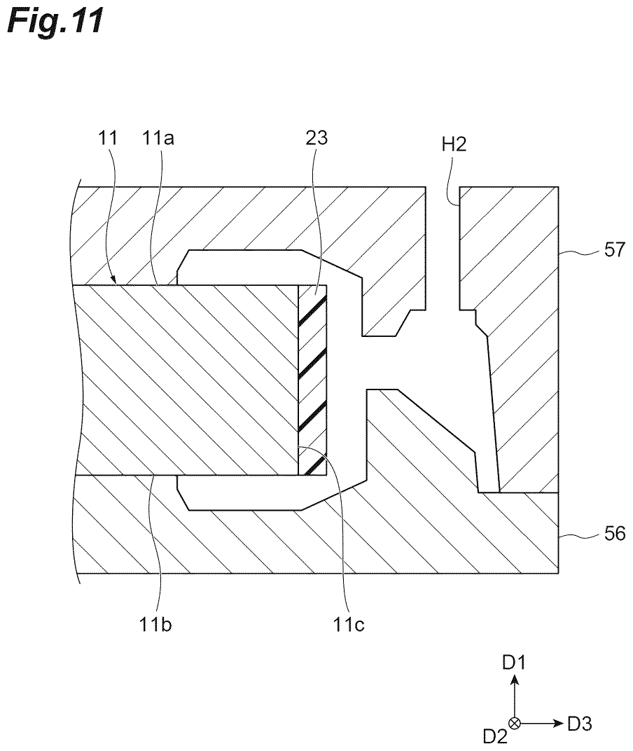

A method for forming the second seal part 12 will next be described. FIG. 10 is a cross-sectional view for describing an inner seal forming step. FIG. 11 is a cross-sectional view for describing an outer seal forming step.

As illustrated in FIG. 10, in a forming step of the inner seal 23 (see FIG. 9), the inner seal 23 is formed along the side surface 11c using a pair of molds 55, 56 which are configured to be detachable from each other in the first direction D1. In a state in which the pair of molds 55, 56 are in contact with each other (closed mold state), a space for disposing the electrode stack 11 and a space for forming the inner seal 23 are provided inside the pair of molds 55, 56.

The electrode stack 11 is disposed such that the entirety of the first end surface 11a and the second end surface 11b are pressed against the molds 55, 56. A compression force in the first direction D1 is applied to the electrode stack 11 by the pair of molds 55, 56. In this state, a resin that forms the inner seal 23 is injected into the pair of molds 55, 56 in a molten state, for example, through an injection port H1 (resin injection gate) that is provided so as to face the side surface 11c. Thus, the third portion 21c (see FIG. 3) is covered by the inner seal 23.

As illustrated in FIG. 11, in a forming step of the outer seal 24 (see FIG. 9), the side surface part 25 is formed along the inner seal 23, and the first projecting part 26 projecting onto the first end surface 11a from the side surface part 25 and the second projecting part 27 projecting onto the second end surface 11b from the side surface part 25 are formed using a pair of molds 57, 58 which are configured to be detachable from each other in the first direction D1. In a state in which the pair of molds 57, 58 are in contact with each other (closed mold state), a space for disposing the electrode stack 11 provided with the inner seal 23 and a space for forming the outer seal 24 are provided inside the pair of molds 57, 58.

A resin that forms the outer seal 24 is injected into the pair of molds 57, 58 in a molten state, for example, through an injection port H2 (resin injection gate) that is provided in a forming space of the column part 72. Thus, the inner seal 23 is covered by the outer seal 24. An outer edge part of the electrode stack 11 and the inner seal 23 are not in contact with the pair of molds 57, 58, and may deform due to the injection pressure of the resin. This may cause the outer edge part of the electrode stack 11 and the inner seal 23 to become displaced in the first direction D1, so that the thicknesses of the first projecting part 26 and the second projecting part 27 may differ. In the power storage module 4, the amount of the resin that flows in tends not to differ between the first projecting part 26 and the second projecting part 27. Consequently, displacement of the positions of the outer edge part of the electrode stack 11 and the inner seal 23 in the first direction D1 inside the molds 57, 58 is suppressed. The reasons for this will be described below.

The rib 70 is connected to the overhang 60 and the first side surface portion 25b of the side surface part 25. In the case in which injection molding is performed with the rib 70 as the injection port of the resin, paths of the resin from the rib 70 to the first side surface portion 25b include a path in which the rib 70 and the first side surface portion 25b are directly connected without passing through the overhang 60 as well as a path that passes through the overhang 60. However, the only path of the resin from the rib 70 to the second side surface portion 25c of the side surface part 25 is a path that passes through the overhang 60. Consequently, the resin injected from the rib 70 flows more easily into the first side surface portion 25b than into the second side surface portion 25c.

The thickness t2 of the second side surface portion 25c is greater than the thickness t1 of the first side surface portion 25b (t2>t1). That is, a flow path area in a direction of flow of the resin in the second side surface portion 25c is larger than a flow path area in the direction of flow of the resin in the first side surface portion 25b. The resin thus flows more easily in the second side surface portion 25c than in the first side surface portion 25b. However, the resin flows more easily into the first side surface portion 25b than into the second side surface portion 25c due to the rib 70 being connected to the first side surface portion 25b. Consequently, the amount of the resin that flows into the portions forming the first projecting part 26 and the second projecting part 27 tends not to differ. As a result, displacement of the positions of the outer edge part of the electrode stack 11 and the inner seal 23 in the first direction D1 inside the molds 57, 58 is suppressed.

The rib 70 also has the column part 72 spaced from the first side surface portion 25b and protruding from the overhang 60 in addition to the plate-like body part 71. The column part 72 is thicker than the body part 71, so that injection molding with the column part 72 as the injection port of the resin facilitates the flow of the resin into the overhang 60, and promotes the flow of the resin from the overhang 60 into the side surface part 25. In other words, the body part 71 is thinner than the column part 72, so that the amount of the resin that flows through the body part 71 can be limited. This can limit the amount of the resin that flows directly from the rib 70 into the first side surface portion 25b without passing through the overhang 60. That is, in this embodiment in which the rib 70 is provided with the column part 72, difference in the amount of the resin that flows into the first side surface portion 25b and the second side surface portion 25c is suppressed compared to a case in which the rib 70 is not provided with the column part 72. Consequently, the amount of the resin that flows into the first projecting part 26 that is positioned downstream of the first side surface portion 25b and the second projecting part 27 that is positioned downstream of the second side surface portion 25c tends not to differ, and displacement of the positions of the outer edge part of the electrode stack 11 and the inner seal 23 in the first direction D1 inside the molds 57, 58 is suppressed. Accordingly, differences in the thicknesses between the first projecting part 26 and the second projecting part 27 can be suppressed. As a result, the strength of the power storage module 4 can be ensured.

The rib 70 has the column part 72 that is thicker than the body part 71. The strength of the rib 70 can thus be increased. Consequently, the strength of the rib 70 can be maintained even if the body part 71 is thin.

The second side surface portion 25c has the thick part 25d at a position facing the rib 70 in the first direction D1 with the overhang 60 interposed therebetween. Thus, a configuration in which the second side surface portion 25c is thicker than the first side surface portion 25b in the vicinity of the rib 70 into which the resin flows is reliably achieved. The thick part 25d enables an average value of the thickness of the second side surface portion 25c to be greater than an average value of the thickness of the first side surface portion 25b, even if the thickness of portions of the second side surface portion 25c other than the thick part 25d is the same as the thickness of the first side surface portion 25b.

The body part 71 is connected to the first side surface portion 25b at a position spaced from the first projecting part 26 in the first direction D1. That is, a predetermined separation distance (distance d1) is provided between the first projecting part 26 and the first body portion 73 in the stack direction. Thus, the distance in which the resin flows from the rib 70 to the first projecting part 26 is greater compared to a case in which the first projecting part 26 and the first body portion 73 are provided at the same position in the stack direction. As a result, differences in the thicknesses between the first projecting part 26 and the second projecting part 27 can further be suppressed.

Although an example embodiment of the present disclosure has been described in detail above, the present disclosure is not limited to the embodiment above.

For example, in the embodiment above, the power storage device 1 includes a plurality of the power storage modules 4 stacked along the first direction D1. However, the number of the power storage modules 4 in the power storage device 1 is arbitrary, and may, for example, be one.

In the power storage module 4, the rib 70 need not have the column part 72. Even in this case, differences in the thicknesses between the first projecting part 26 and the second projecting part 27 can be suppressed by the second side surface portion 25c being thicker than the first side surface portion 25b.

In the power storage module 4, the second side surface portion 25c may have the same thickness as the first side surface portion 25b. Even in this case, differences in the thicknesses between the first projecting part 26 and the second projecting part 27 can be suppressed by the rib 70 including the column part 72 that is thicker than the body part 71.

The second side surface portion 25c need not have the thick part 25d. Even in this case, the average value of the thickness of the second side surface portion 25c will be greater than the average value of the thickness of the first side surface portion 25b, as long as the minimum value of the thickness of the second side surface portion 25c is greater than or equal to the maximum value of the thickness of the first side surface portion 25b.

The column part 72 is not limited to having a circular cross-section, and may have a rectangular cross-section, an elliptic cross-section, or the like.

What is claimed is:

1. A power storage module comprising:
an electrode stack including a plurality of electrodes being stacked; and
a seal provided around the electrode stack to seal a space between the electrodes,
wherein the electrode stack includes a first end surface and a second end surface in a stack direction of the plurality of electrodes, and a side surface extending in the stack direction to connect the first end surface and the second end surface together,
wherein the seal includes:
a side surface part provided on the side surface;
a first projecting part projecting onto the first end surface from the side surface part;
a second projecting part projecting onto the second end surface from the side surface part;
an overhang extending outward of the electrode stack from the side surface part; and
a rib provided on the overhang,
wherein the side surface part includes a connecting portion to which the overhang is connected, a first side surface portion positioned between the connecting portion and the first projecting part, and a second side surface portion positioned between the connecting portion and the second projecting part,
wherein the rib connects the overhang and the first side surface portion together, and
wherein the second side surface portion is thicker than the first side surface portion in a direction orthogonal to the side surface.

2. The power storage module according to claim 1,
wherein the second side surface portion includes a thick part at a position facing the rib in the stack direction with the overhang interposed therebetween.

3. The power storage module according to claim 1,
wherein the rib includes a body part being plate-like, connecting the overhang and the first side surface portion together, and a column part spaced from the side surface part and protruding in the stack direction from the overhang, and
wherein the column part is thicker than the body part in a direction orthogonal to the stack direction and parallel to the side surface.

4. The power storage module according to claim 3,
wherein the body part is connected to the first side surface portion at a position spaced from the first projecting part in the stack direction.

5. The power storage module according to claim 4,
wherein the body part includes a first body portion connected to the first side surface portion, and a second body portion connected to the column part; and
wherein a distance at which the first body portion is spaced from the first projecting part in the stack direction is greater than a distance at which the second body portion is spaced from the first projecting part in the stack direction.

6. A power storage module comprising:
an electrode stack including a plurality of electrodes being stacked along a stack direction; and
a seal provided around the electrode stack to seal a space between the electrodes,
wherein the electrode stack includes a first end surface and a second end surface in the stack direction, and a side surface extending in the stack direction to connect the first end surface and the second end surface together,
wherein the seal includes:
a side surface part provided on the side surface;
a first projecting part projecting onto the first end surface from the side surface part;
a second projecting part projecting onto the second end surface from the side surface part;
an overhang extending outward of the electrode stack from the side surface part; and
a rib provided on the overhang,
wherein the side surface part includes a connecting portion to which the overhang is connected, a first side surface portion positioned between the connecting portion and the first projecting part, and a second side surface portion positioned between the connecting portion and the second projecting part,
wherein the rib includes a body part being plate-like, connecting the overhang and the first side surface portion together, and a column part spaced from the first side surface portion and protruding in the stack direction from the overhang, and
wherein the column part is thicker than the body part in a direction orthogonal to the stack direction and parallel to the side surface.

7. The power storage module according to claim 6,
wherein the body part is connected to the first side surface portion at a position spaced from the first projecting part in the stack direction.

8. The power storage module according to claim 7,
wherein the body part includes a first body portion connected to the first side surface portion, and a second body portion connected to the column part; and
wherein a distance at which the first body portion is spaced from the first projecting part in the stack direction is greater than a distance at which the second body portion is spaced from the first projecting part in the stack direction.
